(19) United States
(12) Patent Application Publication
(10) Pub. No.: US 2009/0003953 A1
(43) Pub. Date: Jan. 1, 2009

(54) Dual router

(76) Inventor: Andrew M. Kvalheim, Petaluma, CA (US)

Correspondence Address: CORWIN R. HORTON, THE PARK, SUITE 2001, 25 MANN DRIVE, KENTFIELD, CA, 94904, US

(21) Appl. No.: 12/152,017

(22) Filed: May 12, 2008

Related U.S. Application Data
(62) Division of application No. 11/196,201, filed on Aug. 3, 2005, now abandoned.

(51) Int. Cl. B23C 3/00

(52) U.S. Cl. 409/192

(57) ABSTRACT

A rotary router for routing at a smaller and a larger diameter, alternatively, and of shifting between the two modes semi or fully automatically. A mandrel carries a first cutter cutting at smaller diameter and a carriage mounted on the mandrel rotates around the same axis and carries a cutter cutting at a wider diameter. The carriage is moveable long the mandrel between a rearward position where the second cutter is inactive and the first cutter is exposed for cutting and a forward position where the second cutter is at an exposed cutting position adjacent and outside the first cutter and the first cutter is inactive for lateral cutting. An interlock device is provided for the mandrel and carriage that stops axial movement of the carriage beyond the forward position and stops rotational movement between the mandrel and the carriage while the carriage is at the forward position.

### BACKGROUND OF THE INVENTION

This invention relates to routers, in particular, tools that rotate about an axis having at an axial end thereof cutters that cut both in the axial direction and transverse to the axial direction. Usually routers are powered by a rotary electrical motor having a clamping device at the terminal end of its arbor, termed a chuck, for gripping the shank end of the routing tool and rotating the tool coaxially with the arbor. Router tools normally have a cutting head with one or more cutters or bits at the working end. Most routing tools may be rotated and plunged into a substrate along the direction of the tool axis of rotation to cut an opening of a particular diameter. When the cutting head of the tool is below the surface level of the substrate the tool may be moved transversely to the tool axis and the cutting head will cut a path in the substrate that is the same width as the diameter of the opening cut by the cutting head. For cutting transversely to the tool rotational axis, the tool will have one or more cutting elements that cut transversely to the tool axis. The lateral cutting elements face outwardly from the tool axis from a position outward of the tool axis. The lateral cutting elements will extend in the tool axis direction a distance equal to the greatest routing depth desired for the tool. In the case of routing tools designed for use in routing hinge pockets for doors, which are typically about two to three sixteenth inch deep, so lateral cutting elements for such routers normally will extend at least one quarter inch and more typically up to one half inch or longer. The tool will typically also have a face cutter located at the forward end of the lateral cutters for cutting in the forward direction when the face cutter is plunged into the substrate. In some instances, where rotary routers are to initiate a cut solely by entering the substrate from a side edge or from a pre=existing hole, rather than by plunging down into the substrate, a face cutter may be omitted.

Routers are employed to mill various substrates and particularly wood and other workpieces. They typically comprise a revolving spindle or shaft with a cutter at its front end and a motor connected to the other end of the spindle to rotate it. They are used for milling at the surface of both metal and wood, for example cutting hinge pockets, latch pockets and bore holes for door bolts in the manufacture of “prehung” doors with associated doorjambs.

Machines for manufacturing prehung doors typically have one or more router modules for creating hinge pockets at the side edge of a door and a door jamb. Typical of such modules is the butt router module described at Column 6, lines 7-38 of Knighten U.S. Pat. No. 6,561,238. These router assemblies move the routing tool in three directions, a forward or plunging direction to and into the door edge to the desired depth of the mortise, and in the directions transverse to the axis of the tool, namely the direction along the door edge and the direction across the door edge. The distance in each of these directions is settable for the dimensions of the mortise desired.

Hinges applied to doors typically have generally rectangular leaves that are curved at their two free ends and such curves on some hinges are ¼^{th} inch and for others a radius of ⅝^{th} inch. In this application it may be necessary to frequently change from one style of hinge to the other, in the middle of an operation. To conform the hinge pocket shape to the new hinge at each hinge change, each time a new router having the appropriate cutting diameter must be substituted. This requires dismounting the tool from the motor connection and installing another tool. This results in downtime and additional operator time. To change the width of the cutting path of the tool, it is necessary to either replace the cutting head or the entire tool. This requires dismount and of the cutting head or the entire tool from the motor and replacement. Additionally, if the replacement router tool is shorter or longer, the router module will have to be reset to accommodate the different length. Thus, substantial operator intervention and downtime results.

In industrial applications, such as hinge pocket mortising operations, routing speed is important and it is desirable to operate rotary routers at a speed range of 13,000-14,000 rpm and even as high as 17,000 rpm. It is important for a routing tool designed for such speeds to be as compact, well-balanced and light as possible to minimize inertial and centrifugal forces that could destabilize the tool.

U.S. Pat. No. 6,561,238 describes a cutting tool that may be used for both routing and boring applications on a wooden door. A first bit is mounted at the forward end of a spindle of a rotary tool for rotation with the spindle. This bit may be used for routing to the depth of this bit for forming latch pockets in the door. Behind the first bit and fixed thereto is a second bit mounted for rotation with the spindle. The second bit is of a larger diameter for drilling a latch or lock bore in the door to a substantially greater depth. This arrangement permits the tool to carry out two different operations without having to change bits. However, neither bit can operate independently of the other. Nor is this arrangement capable of carrying out other tool operations.

U.S. Pat. No. 6,676,340 describes rotating tool for surface machining of a workpiece having cutting edges extending from the tool body axially forward of the working tool end face thereof. The tool body is provided with deburring devices each containing a wire brush that is retractable to a storage position within the tool body and extendable to an active position forward of the working tool end face to deburr the face of the workpiece being machined by the cutting edges of the tool. A piston in each deburring device to move the wire brush between the retracted position and the extended active position. In the extended position the deburring wire brush extends forward of the tool end face to or beyond the tips. The cutter tips may also be moved in the axial direction to a greater or lesser extent beyond the working end face of the tool. Movement in the axial direction of either the cutter tips or the brushes requires an actuating force and either a pressurized fluid or an electromechanical force is proposed. For this a pressurized fluid or electrical feed to the rotating tool must be supplied from outside of the rotating tool through a hollow fastening shank into the tool body. This approach is complex, costly and increases the bulk of the tool.

U.S. Pat. No. 3,127,663 discloses a routing tool that is capable of adjustment to change the diameter of the cut made by the tool. This tool has two opposed cutter elements equidistant from the longitudinal axis of the tool. Spacers of varying widths may be introduced between the two elements to change the effective diameter of the cutter. However, change the diameter of the cutter requires down time and an operator to dismantle the tool in order to change the spacers.

U.S. Pat. No. 3,778,179 discloses a dual hole cutter comprising a larger diameter hole saw carried on a tubular shaft that is to be mounted on a motor drive. A smaller diameter hole saw is nested within the larger hole saw and is carried on a smaller shaft that extends rearward through the larger hole saw and a distance farther rearward inside the hollow shaft. The hollow shaft has a slot opening extending a distance therealong and the small shaft has an upstanding arm radiating therefrom and that extends through the slot opening in the hollow shaft. The shaft at either end has an offset locking slot for receiving the small shaft arm when the small shaft is moved to the respective end and rotated. When the small shaft is moved rearward and rotated to lock the shafts together, the smaller diameter hole saw is in its nested position within the larger hole saw. In that position the larger hole saw may be operated and the smaller hole saw is inactive. To bring the smaller hole saw to a forward position the small shaft is first counter-rotated to bring the shaft arm back into the slot. Then the smaller shaft is moved forward to bring the shaft arm to the forward end of the slot. The shaft is then rotated to bring the shaft arm into the locked position in the forward locking slot. The smaller hole saw, thereby placed in its forward position, is necessarily forward of the larger hole saw, as it can only function at such an extended position.

Circular hole saws, such as described in this patent are intended and designed for sawing into a workpiece in the direction of the principal axis of the tool. They do not have any lateral or side cutting means and thus cannot cut sideways even when force is applied to the tool transverse to its axis. They have no means for removing the plug of material created inside the hole saw as it cuts downwardly into the workpiece, except by cutting completely through to the other side thereof and ejecting the plug from the saw. Moreover, since in this design the outer hole saw is a fixed part of the driving shaft and thus immovable in the axial direction, for the smaller hole saw to operate it must be well forward of the larger hole saw, which necessarily has a fixed position. Thus, if this tool were used in an automated operation, as in the case of routers, the controls would require resetting every time in order for the tool to operate at the preset depth index position.

### SUMMARY OF THE INVENTION

This invention relates to rotary routers and particularly to router tools capable of shifting between a router having a smaller cutting diameter and a router having a larger cutting diameter semi-automatically, with only simple and rapid manual procedures required, or fully automatically.

The routing tool of this invention comprises a rotatable mandrel adapted for mounting on a motor arbor, for rotation with the arbor but otherwise fixed to the motor and movable in the tool axis direction or transverse thereto only with the motor. The mandrel carries at its forward end a central cutter having one or more lateral cutting elements for cutting outwardly of the tool axis transversely to the axial direction and, desirably, one or more forward or face cutting elements for cutting in the forward axial direction. A carriage is mounted concentrically on the mandrel for movement therealong in the axial direction. The carriage carries at its forward end a cutting head that supports at least one cutter at a position, from the tool axis, that lies outward of the central cutter. The outlying cutter has at least one lateral cutting element that is positioned to cut outwardly of the tool axis and transversely to the axial direction and, preferably, one or more forward cutting elements that cut in the forward axial direction. Preferably, the forward cutting elements of both the central cutter and of the outlying cutters comprise one or more cutting edges that are generally perpendicular to the longitudinal axis of the tool. Preferably the lateral cutter elements of both the central and outlying cutters comprise one or more cutting edges that extend rearward from the a respective forward cutting edge a distance generally along the longitudinal axis of the tool.

The carriage is moveable axially relative to the mandrel between a rearward position and a forward position. At the rearward position of the carriage the outlying cutter is inactive and the central cutter is at an advanced active position for routing by itself. At the forward position of the carriage the outlying cutter is at an advanced active position and the lateral elements of the central cutter for cutting transversely to the axial direction are in an inactive position.

In this invention where both the central and outlying cutters have forward cutting elements, when the carriage at the forward position, the forward cutting elements of the central cutter may be axially rearward of the outlying cutters. However, advantageously, the forward position of the carriage is at a location along the tool axis at which the forward cutting elements of the central cutter are adjacent the outlying cutters, desirably with the forward cutting elements of the central cutter located at a distance forward of the rearward end of the lateral cutting elements of the outlying cutters. Preferably, with the carriage at the forward location, the forward cutting elements of the central cutter are essentially coterminous along the tool axis. With this configuration the forward cutting elements of the central cutter are in position to cut forward with the outlying cutters when the tool is plunged into a workpiece. This helps to eliminate the plug of material lying inward of the outlying cutter path which may impede or prevent lateral movement of the tool in a routing path. Also, with the forward cutting elements of the central cutter coterminous, the depth of the cut with the tool will be the same whether the central cutter is the advanced active position or the carriage is forward bring the outlying cutter into the active position. This can be important for avoiding indexing problems and resetting delays in use of the tool in an automated router module.

In another feature of this invention when the carriage is moved to the forward position the mandrel drives rotation of the carriage and the outlying cutters carried by the carriage. For this purpose an interlock device is provided for the mandrel and carriage that releasably holds the carriage at the forward position and stops rotational movement between the mandrel and the carriage while the carriage is at the forward position. The interlocking device may be actuated when the carriage is at its forward position to prevent the carriage from moving to the other end of the path until it is desired to switch cutters. The carriage may be moved back to the rearward position after releasing the interlocking device.

In another feature of the invention a detent is provided for the carriage to maintain the carriage at its rearward position while the mandrel is rotated for using the implement carried by the mandrel. A magnet is placed at the rearward end of the carriage that during rotation of the mandrel both holds against the carriage on its forward side and against a collet on the shank end of the mandrel or the chuck of the motor on its rearward side to prevent forward movement of the carriage.

In an embodiment of the invention, movement of the carriage between the active and inactive positions may be effected partially or completely by use of an externally threaded section on the mandrel meshing with an internally threaded sleeve on the carriage. In one such embodiment the threaded section extends partially along the mandrel in the forward direction of the carriage from an intermediate point. The carriage is slidable from the rearward position to where the threaded section of the mandrel is first engaged by the threaded sleeve on the carriage. The carriage may then be rotated relative to the carriage to screw the carriage the remaining way to the forward position.

In another such embodiment the threaded section on the mandrel extends along the mandrel over a distance to permit the carriage to be screwed completely between the forward and rear position. In this embodiment, a reversible rotation motor may be employed for driving the mandrel so that carriage may be urged in either direction, simply by reversing the direction of rotation. If the friction between the mandrel and the carriage is low enough and the inertia of the carriage is great enough, the carriage may thus be screwed by the reversible motor fully between the active and inactive positions However, as an additional feature in case the inertia of the carriage is too small to engender relative rotational movement between the carriage and the mandrel, friction may be applied to the carriage, either mechanically or manually to impede its rotation to permit the rotating mandrel to screw the carriage between the active and inactive positions.

As another feature in the foregoing screw-driven embodiments, a stop or interlock is provided that is operative, when the mandrel is rotated in the direction to move the carriage toward the forward position, to stop the carriage at the forward position and to stop relative axial rotational movement between the carriage and mandrel when the mandrel continues to rotate in that direction.

In another embodiment of the invention a router tool is provided that is fully automatic in shifting between a router having a smaller cutting diameter and a router having a larger cutting diameter. In this embodiment a pneumatic cylinder motor having cylinder and piston components is placed rearward of the carriage with one of the components being fixed to the mandrel for rotation therewith and with the component of the motor fixed to the carriage. Advantageously, both the cylinder and its piston components are mounted on the mandrel, being received therethrough, concentrically with the mandrel axis. The piston is slidable on the mandrel and within the cylinder to permit the piston to be impelled by gas pressure in a stroke to move the carriage between the forward and rearward positions. Preferably, the motor is arranged with the cylinder fixed to the mandrel and the piston fixed to the carriage.

As an additional feature of this embodiment, a dispenser or dock for supplying compressed gas to the cylinder is provided. A compressed gas supply dock is placed adjacent the rearward wall of the cylinder and mounted on the mandrel for rotation about the tool axis but is fixed at its position along the tool axis. A rotary seal is positioned around the tool axis between the dock and the rearward wall of the cylinder. A first component of the rotary seal is at the side of the dock toward the cylinder rearward wall and is fixed thereto. The first seal component extends outwardly of and encircles the mandrel and has a face toward the cylinder rearward wall. A second seal component on the side of the cylinder rearward wall toward the dock and is fixed thereto. The second seal component also extends outwardly of and encircles the mandrel and this component has a face confronts and is spaced from the face of the first cylinder component to form an interface gap therebetween.

One or more passages extend from a port at the exterior of the dock for introducing compressed gas into the dock and through the dock and inwardly through the rotary seal to and through the rearward end the cylinder into the interior thereof behind the piston. The gap between the rotating seal components is sufficient wide to avoid frictional contact therebetween and close enough to permit the gas supply into cylinder at a pressure sufficient to force the carriage to the forward position and hold the carriage at that position during operation of the drill.

As a further feature, a chamber is included as an intermediate portion of the passage at the interface between the seal components. The chamber at the dock side communicates with the with passage or passages coming from the dock and at the cylinder side with the passage or passages going through the rearward wall of the cylinder into the cylinder. The chamber encircles and is spaced outwardly from the mandrel and inwardly from the rotating seal. The chamber extends to the gap at the interface between the seal components and, desirably, across the interface for a distance on the other side of the interface. The chamber preferably is in the form of confronting annular channels, one to each side of the interface, each concentric with the tool axis, with both channels open to each other at the interface. The chamber at the interface of the rotating seal allows continuous communication of the passage as it crosses the interface between the relatively rotating seal components.

The rotating seal provides a means of providing compressed gas to the rotating cylinder from a stationary source, the dock that is stationary as the mandrel, by which it is supported, rotates. As the tool may desirably used at rotational speeds that may exceed 14,000 rpm and be as high as 17,000 rpm, direct contact between faces of a rotating seal may cause a dangerous amount of friction and possible seizing up. Accordingly, in this invention a seal is provided that has a positive but small gap that is sufficient to avoid friction between the faces when they rotate relative to one another. At the same time, the gap is maintained small enough so that the amount of gas leakage out the gap is small enough that sufficient gas pressure may be maintained in the passage and the cylinder to force the piston to bring and hold the carriage at the forward position during operation of the tool. For this purpose the gap is desirably at about one to two thousands of an inch. Quite accurate machining of the seal components and faces is desirable to maintain a clearance this small without surface contact between the faces.

The faces of the seal components desirably conform or mate with one another to maintain a uniform gap width. Preferably both faces are planer and perpendicular to the tool axis. If desired, the seal surfaces may be at another angle to the tool axis and may have angled or curved surfaces so long as they conform to one another and the surface around the seal at any point along the tool axis is equidistant to the tool axis so that a minimum gap can be maintained between the surfaces as the two surfaces rotate relative to each other during operation.

A cylindrical tool brace and shroud is desirably mounted on the cylinder to extend forward and surround the carriage, when the carriage is at the forward position. The brace has an internal diameter slightly larger than the carriage so as to normally be spaced from the carriage but is close enough to provide lateral support to the carriage and mandrel when the tool is subjected to bending forces transverse to the tool axis.

As seen from the foregoing, all of the embodiments contemplate a central mandrel bearing the central cutter that has a shank adapted for mounting on an arbor that supports a carriage bearing the outlying cutters. This design is particularly suitable for the dual router of this invention as it permits the use as the mandrel of a solid central shaft that provides good resistance to the bending and shear forces the tool is subjected to in routing operations. Additionally, this relationship permits a more compact and lighter design, minimizing size, weight and inertia of the unit.

### BRIEF DESCRIPTION OF THE DRAWINGS

FIG. 1 is an isometric view of an embodiment of the rotary tool of the present invention, taken from the forward end of the tool, with the carriage in its rearward position and showing the outer cylindrical section of the carriage as semi-transparent to facilitate viewing of the underlying structure;

FIG. 2 is a side view of the tool of FIG. 1;

FIG. 3 is an exploded view of the tool as shown in FIG. 2, showing the major components separately;

FIG. 4 is the same isometric view as in FIG. 1 of the tool of FIGS. 1, 2 and 3 but with the carriage at its forward position;

FIG. 5 is a side view as in FIG. 2 of the tool of FIG. 1 but with the carriage at its forward position;

FIG. 6 is a is an isometric view of the tool of FIGS. 1 through 5 mounted in the chuck of a rotary motor;

FIG. 7 is an isometric view of another embodiment of the rotary tool of the present invention, taken from the forward end of the tool, with the carriage in its forward position and showing the outer cylindrical section of the carriage as semi-transparent to facilitate viewing of the underlying structure;

FIG. 8 is the same isometric view as in FIG. 7 of the tool of FIG. 7 but with the carriage at its rearward position;

FIG. 9 is an exploded view of the tool as shown in FIGS. 7 and 8, showing the major components separately;

FIG. 10 is an isometric view as in FIG. 7 of the tool of FIG. 7 but showing an alternative interlocking device;

FIG. 11 is the same isometric view as in FIG. 10 of the tool of FIG. 10 but with the carriage at its rearward position;

FIG. 12 is an exploded view of the tool as shown in FIGS. 7 and 8, showing the major components separately;

FIG. 13 is an isometric view of yet another embodiment of the rotary tool of the present invention, taken from the forward end of the tool, with the carriage in its forward position and showing the outer cylindrical section of the carriage as semi-transparent to facilitate viewing of the underlying structure;

FIG. 14 is the same isometric view as in FIG. 13 of the tool of FIG. 13 but with the carriage at its rearward position;

FIG. 15 is an exploded view of the tool as shown in FIGS. 13 and 14, showing the various components separately; including the collet; and

FIG. 16 is an isometric view of the tool of FIGS. 13 and 14 mounted in the chuck of a two-way rotary motor having a brake system for the tool carriage.

FIG. 17A is an isometric view of yet another embodiment of the rotary tool of the present invention, taken from the rearward end of the tool, with the carriage in its rearward position;

FIG. 17B is an isometric view of the tool of FIG. 17A taken from the forward end of the tool, with the carriage in its rearward position;

FIG. 17C is an isometric view of the tool of FIGS. 17A taken from the forward end of the tool, with the carriage in its forward position;

FIG. 18 is a side view of the tool of FIGS. 17A, 17B and 17C with the carriage in the rearward position;

FIG. 19 is an isometric exploded view taken from the forward end of the tool of FIGS. 17A through 18 showing the various components separately;

FIG. 20 is a front view of the cylinder shown in FIG. 19, as seen from the plane 20-20;

FIG. 21 is an isometric exploded sectional view of the tool of FIGS. 17A through 20 as seen from the plane 21-21 in FIG. 19, but taken from the rearward end of the tool:

FIG. 22 is an isometric sectional view of the tool of FIGS. 17A through 21 as seen from the plane 22-22 in FIG. 17A showing the carriage and piston in the rearward position;

FIG. 23A is a sectional view of the tool of FIGS. 17A through 22 as seen from the plane 23A-23A in FIG. 18, showing the carriage and piston in the rearward position;

FIG. 23B is the same sectional view of the tool of FIGS. 17 through 23A as seen in FIG. 23A, but showing the carriage and piston in the forward position;

FIG. 24 is a fragmentary cross-sectional view corresponding to a mid portion of FIG. 23B, but enlarged; and

FIG. 25 is a fragmentary sectional exploded view corresponding to a mid portion of FIG. 23B, showing the details of the cylinder and dock.

### DETAILED DESCRIPTION OF THE PREFERRED EMBODIMENT

The following description illustrates the manner in which the principles of the invention are applied but is not to be construed as limiting the scope of the invention.

Embodiments of the invention include dual router tools that may change one router of small diameter a router of an effectively greater diameter automatically and others that are changed semi-automatically. Both automatic and semi-automatic embodiments will be illustrated.

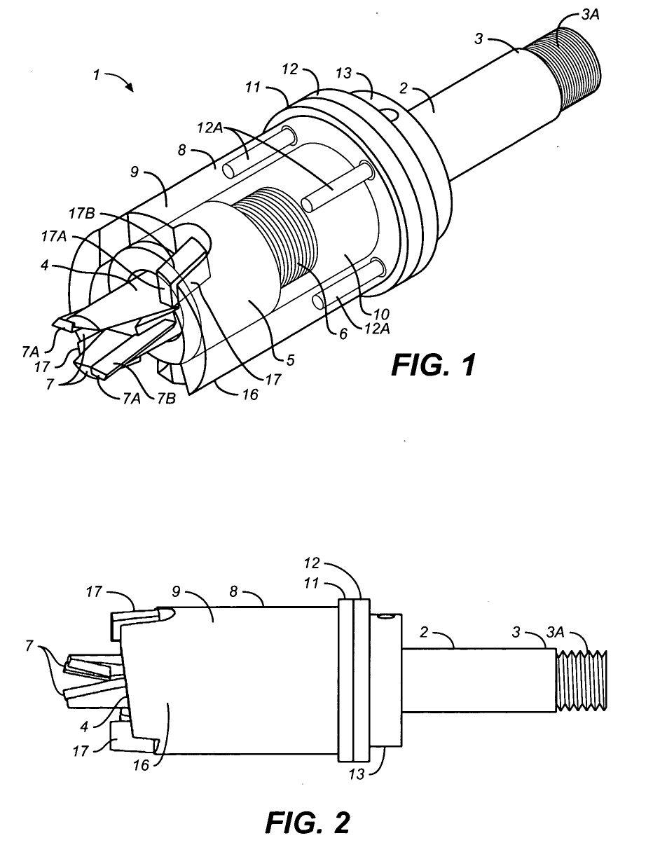

Semi-automatic changeover router tools may be particularly adapted for use with motors that are capable of rotating only in a single direction. Referring to the drawings, particularly to FIGS. 1, through 6, a semi-automatic changeover binary tool 1 is shown having a mandrel 2 with a shank end 3 at its back for engagement in the chuck of motor arbor (not shown). Shank end 3 is threaded to receive a collet retaining nut as will be described.

At the front (working) end of mandrel 2 is a milling implement 4 for routing comprising a forked cutting head. Implement 4 may be secured to the forward end of mandrel 2 by a screw, as will be described at a later point. A brass bushing 5 is shrunk fit on a section of mandrel 2. Immediately to the rear of implement 4 mandrel 2 has an externally threaded portion 6 with left-handed threads that extends rearward along mandrel 2 for a distance but leaving an unthreaded portion to shank 3.bits 7

Implement 4 has a pair of cutting bits 7 to provide an effective cutting diameter of ½ inch. Typical for this type of router head, implement 4 cuts primarily sideways rather than in the axial direction of the mandrel. Bits 7 are designed to cut in counter-clockwise rotation, looking from in front of implement 4. As seen in FIG. 1, each cutting bit 7 has a forward cutting edge 7A that cuts forward in the axial direction of the tool and a side blade edge 7B that cuts sideways.

Extending around mandrel 2 is a carriage 8 that is movable along the axial direction of mandrel 2 and rotatable about the mandrel along the same axis, as will be discussed. Carriage 8 has an outer brass cylindrical section 9 sized so that it may be received on mandrel 2 and over bushing 5 and an inner smaller diameter cylindrical section 10 toward the rear of carriage 8 enclosed by section 9. Section 10 has an integral flange 11 at its rearward end. A flange 12 of a magnetizable metal such as steel is located at the rearward side of flange 11. Screws 12A extend through flanges 11 and 12 and into cylinder 9 to secure together the components of carriage 8.

Flanges 11 and 12 both embrace mandrel 2 and are slidable therealong rearward of threaded portion 6. Cylinder section 10 is provided with internal threads 15 sized to mesh with the external threaded portion 6 when carriage 8 is moved forward along the mandrel and the mandrel rotated in counter-clockwise direction, looking from in front of mandrel 2.

A disc-shaped magnet 13 is mounted on an oilite bushing 14, which in turn is slidably mounted as a collar on mandrel 2 between steel flange 12 of carriage 8 and shank end 3 of mandrel 2. Shank end 3 has an externally threaded section 3A at its terminal end for receiving a retaining nut, as will be discussed later.

A router head 16 is mounted at the forward end of carriage 8 extending forward from cylinder section 9. Router head 16 has a pair of cutting bits 17 to provide an effective cutting diameter of 1 and ¼ inches. As with implement 4 router head 16 cuts primarily sideways of the mandrel. Bits 17 are also designed to cut in counter-clockwise rotation, looking from in front of mandrel 2. Each bit 17 has a forward cutting edge 17A that cuts forward in the axial direction of the tool and a side blade edge 17B that cuts sideways.

Both implement 4 and router head 16 are specifically designed for operation at a limited depth and to mill moving primarily in the plane perpendicular to the rotational axis of the tool. They are thus particularly useful for milling hinge and latch pockets in doors.

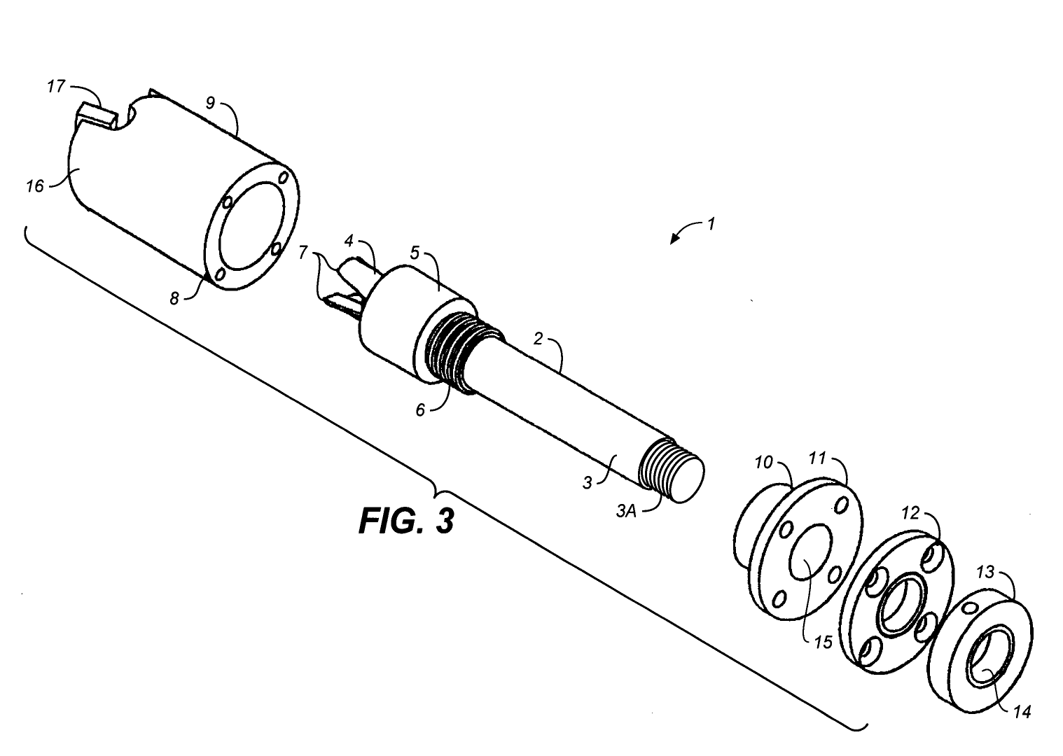

As can be seen in FIG. 1 through 3, when carriage 8 is in its rearward or retracted position, section 8 thereof is rearward of threaded portion of mandrel 2 and the respective threads of the mandrel and carriage are not engaged. At this retracted position implement 4 on mandrel 2 is in the active position forward of router head 16 and exposed for routing operations.

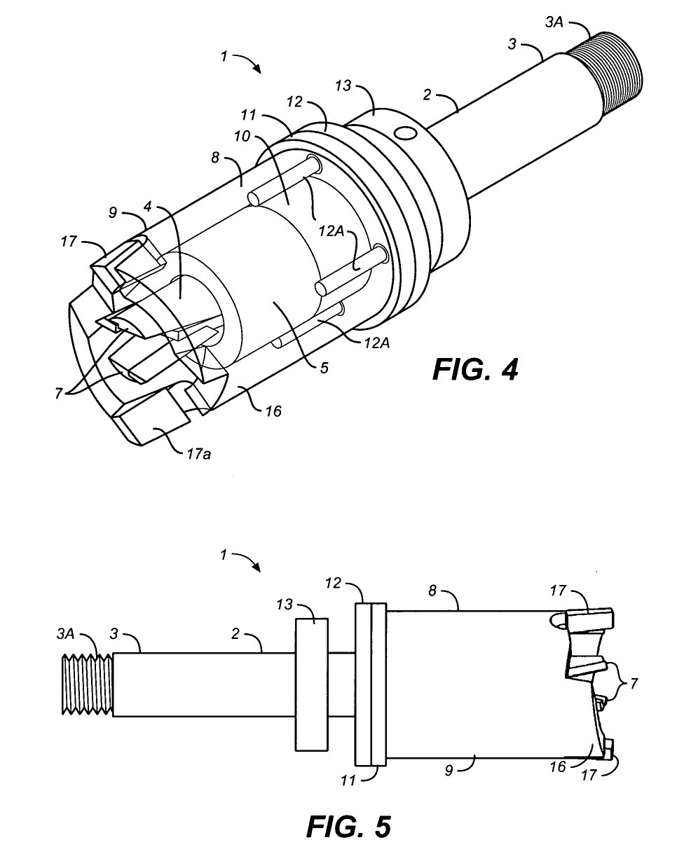

To move carriage 8 to its active position, it is first moved forward to bring cylinder 10 to the mandrel threaded portion 6. Then, by rotating the carriage in the clockwise direction, looking from in front of mandrel 2, threaded portion 6 may be engaged with threads 15 of section 10 and carriage 8 thus screwed forward along mandrel 2 to its forward active position as shown in FIGS. 4 and 5 with the forward end of cylinder section 10 lodged against the rear end of bushing 5. At this position implement 4 is fully retracted to within router head 16 and cylinder section 9. Thus, in this position, implement 4 is in the inactive position and router head 16 exposed for routing operations. As seen in FIGS. 4 and 5, at this forward position the cutting bits 17 of router head 16 are axially adjacent to bits 7 of implement 4 with the forward blade edges 17A of bits 17 essentially coterminous along the tool axis with the blade edges 7A of bits 7. At this position the forward blade edges 7A of each bit 7 is still exposed to cut forward in the axial direction along with the forward blade edges 17A of bits 17. However, the side blade edges 7A are no longer exposed and are inactive.

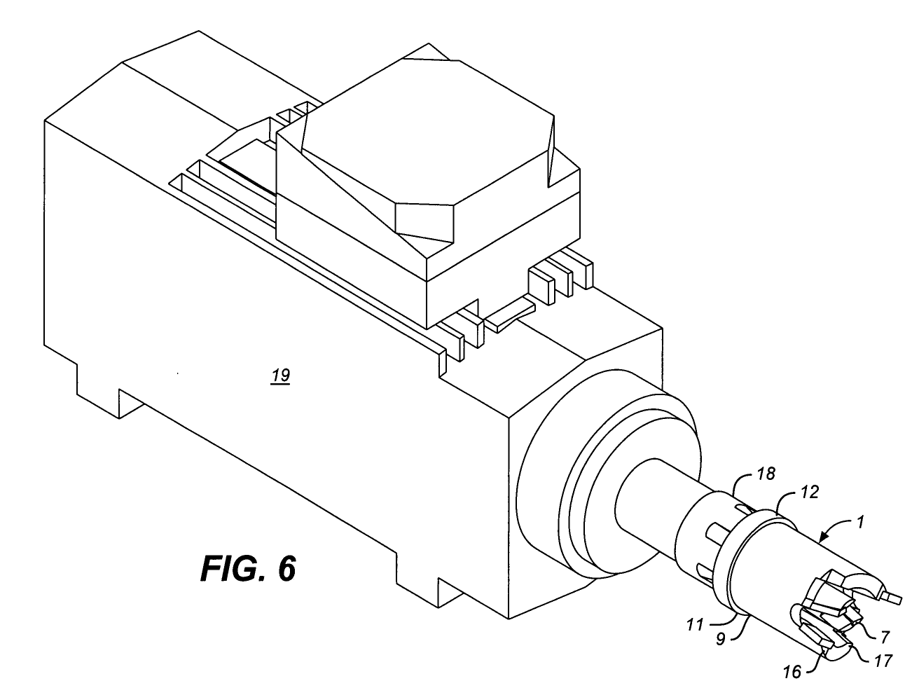

In use, as seen in FIG. 6, the shank end 3 of tool 1 is secured in the chuck 18 on the arbor of a motor 19 that is rotatable in the counter-clockwise direction, looking toward the motor arbor from in front of the chuck. Then, with carriage 8 at the forward position, the carriage may be rotated by hand in the clockwise direction looking from in front of mandrel 2 while holding mandrel 2 from rotation. This will screw carriage 8 backward along mandrel 2 until cylinder section 10 is behind threaded portion 6. From there carriage 8 may be pulled freely by hand fully back to the retracted position. As seen in FIG. 6, with carriage 8 at the retracted position, magnet 21 will hold against carriage 8 on one (forward) side and against the chuck on the motor on the other (rearward) side, thus preventing carriage 8 from moving forward during use of implement 4.

When it is then desired to switch back to router head 16, the procedure is reversed, Carriage 8 is pulled forward by hand, overcoming the magnet force, up to threaded portion 6 of mandrel 2. Then carriage 8 is rotated by hand, while holding mandrel 2 from turning. This will engage the threads of threaded portion 6 with the threads of internal threads 15 of inner cylinder section 10 to screw carriage 8 forward along mandrel 2, until the front end of cylinder 10 lodges against the back end of bushing 5. Bushing 5 acts as an interlocking device by stopping further forward movement of carriage 8 and stopping relative rotation between of carriage 8 about mandrel 2 when mandrel 2 continues to rotate at that position.

The foregoing binary tool may also be modified for use with a motor that is rotatable only in the clockwise direction, looking toward the motor arbor from in front of the chuck, as follows. The left-handed threads of externally threaded portion 6 of mandrel 2 are replaced with right-handed threads. This will cause carriage 8 to be screwed forward by the clockwise rotation of the motor and thus of mandrel 2 and hold router head 16 at the active position. The implements employed will need to be those operable upon clockwise rotation, e.g. with cutter blades designed for operation in clockwise rotation.

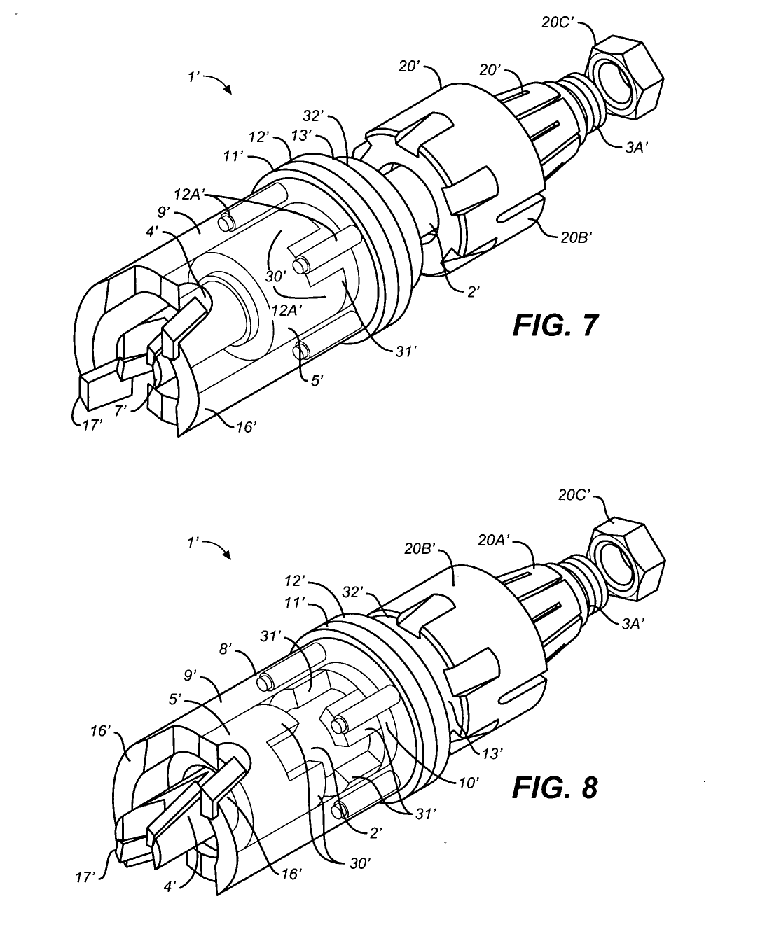

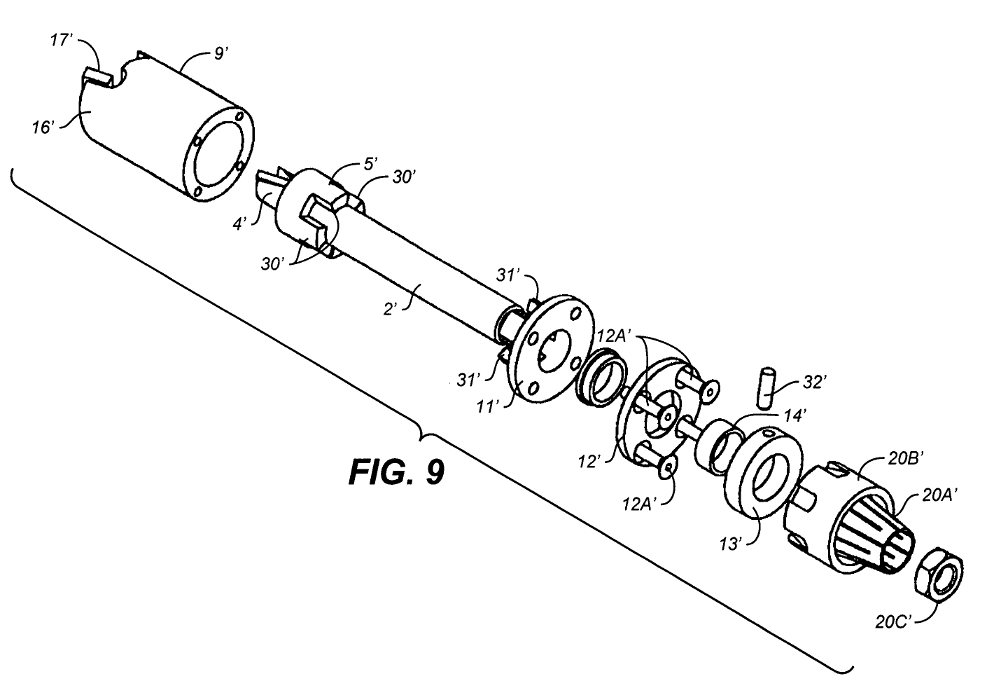

Another embodiment of the invention is illustrated in FIGS. 7, 8 and 9. The tool of this embodiment may be operated by a motor having either clockwise or counter-clockwise rotation, with selection of routers operating in the rotational direction of the motor. In this embodiment with the following noted differences, the tool construction is the same as described in the embodiment of FIGS. 1 to 6, with corresponding elements having the same reference numbers as found for that embodiment except that the numbers are primed.

In this embodiment mandrel 2′ has no threaded portion. Instead, over its entire length mandrel 2′ has a smooth surface. Similarly, inner cylinder section 10′ has no internal threads 15 and its central opening is simply in slidable contact with mandrel 2′. In this embodiment locking elements are provided on the mandrel and on the carriage that interlock when the carriage is at the forward position to prevent relative rotation between the mandrel and the carriage.

Specifically, at its rearward end bushing 5′ has locking lugs 30′. At its forward end inner cylinder section 10′ has locking lugs 31′ that are engagable with lugs 30′ when carriage 8′ is moved forward and rotated to mating position.

Additionally, a releasable retainer operable to selectively retain the carriage at the forward position is provided for this embodiment. For this magnet 13′ is provided with a set screw 32′ that may be used to selectively fix its position along mandrel 2′. Thus, magnet 13′ may be fixed by set screw 32′ immediately behind carriage 8′, when it is at the forward position, to maintain it there. Also, magnet 13′ may be fixed by set screw at a rearward location near the shank end of mandrel 2′ so that carriage 8′ rather than allowing it float along mandrel 2′ when carriage 8′ moves to the rearward position. This may more securely fix carriage 8′ at its rearward position. A set screw may be employed similarly in other embodiments, such as that of FIGS. 1 to 6, to fix the magnet more firmly at the rearward position.

A collet 20′ is fixed on shank end 3′ of mandrel 2′ comprising a collet body 20A′ and ring nut 20B′ for compressing body 20A′ against shank end 3′. A retainer nut 20C′ is screwed onto shank end 3′ collet 20′ from slipping rearward off of shank end 3′.

Operation of tool 1′ is as follows. To bring router head 16′ from the inactive to the active position, carriage 8′ is slid forward manually until cylinder section 10′ and bushing 5′ are adjacent. Carriage 8′ is then rotated by hand to bring lugs 30′ into an orientation that they will mate with lugs 31′. Carriage 8′ is then pushed further forward to mate lugs 30′ with lugs 31′ and thereby lock carriage 8′ from rotating relative to mandrel 2′. Then set screw 32′ is set to prevent axial movement between carriage 8′ and mandrel 2′. By this interlocking, router head 16′ will turn with mandrel 2′ for routing and carriage 8′ will remain at the forward position during use of router head 16′.

To move router head 16′ from the active to the inactive position, (and thus implement 4′ from the inactive to the active position), set screw 32 is first released and carriage 8′ pulled manually back to its rearmost position adjacent the chuck of the motor. There, float magnet 13′ hold against carriage 8′ on its forward side and against the chuck on the motor (not shown) on its rearward side, thus preventing carriage 8 from moving forward during use of implement 4.

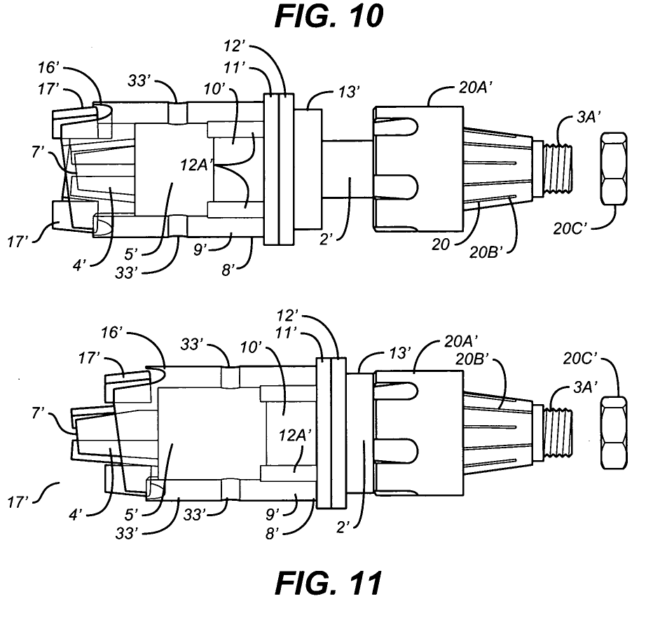

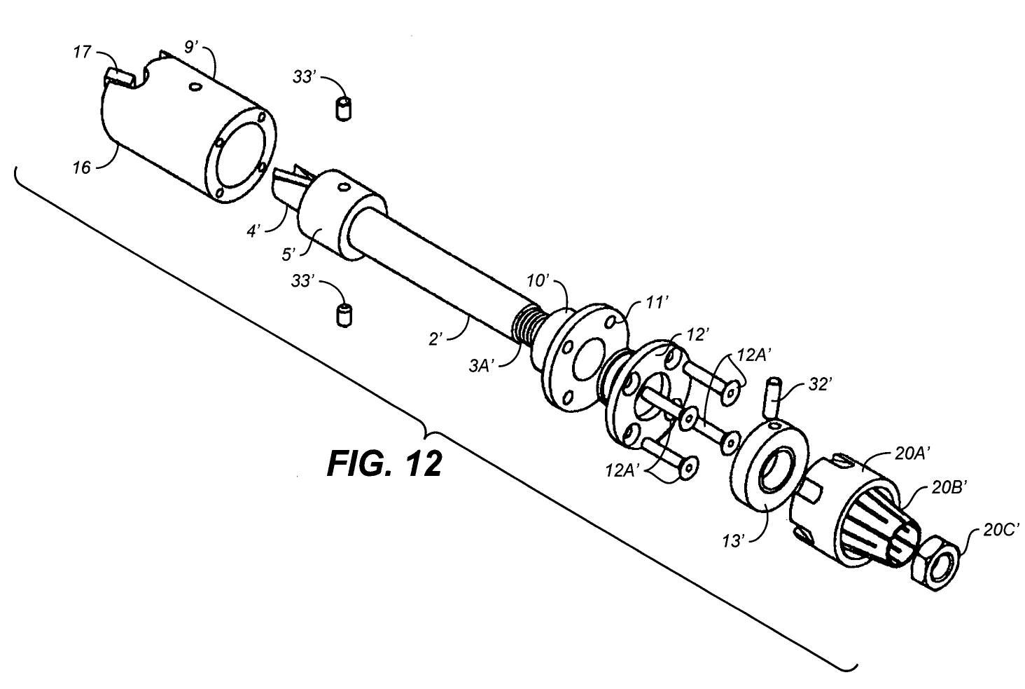

As illustrated in FIGS. 10 through 12, various other expedients may be employed to lock carriage 8′ at the forward position and from rotating relative to mandrel 2′ when at that position. In this example at their abutting ends bushing 5′ has no lugs 30′ and inner cylinder section 10′ no lugs 31′. Instead, as an interlock, a capped, threaded pin 33′ at either side of carriage 8′ may be inserted through an opening 34′ in outer cylindrical section 9′ and into a threaded hole tapped in bushing 5′ in register with opening 34′ when carriage 8′ is at the forward position. Pins 34′ may thus be inserted when it is desired to use router head 16′ with carriage 8′ at the forward position. Pins 33′ are then removed when it is desired to move carriage 8′ to the rearward position.

The routing tools described above may be for use at very high revolutions per minute of rotation. For safety it is important that such tools have a good weight balance around the axis of rotation so as to avoid dangerous vibration due to unbalanced centrifugal forces.

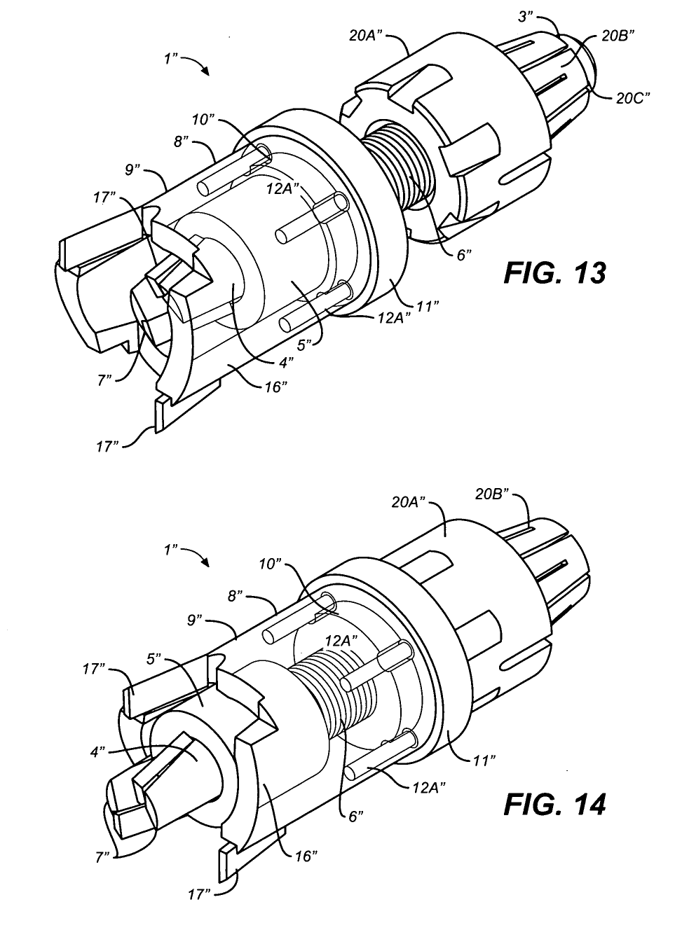

A motor capable of both clockwise and counter-clockwise rotation may be employed for all of the foregoing embodiments, with the selection of the appropriate direction of rotation. Additionally, these motors may be employed with special embodiments of the invention that are capable of essentially automatic changeover of routing implements. Such an embodiment is shown in FIGS. 13 through 16, with corresponding elements having the same reference numbers as found in the embodiment of FIGS. 1 through 6, except that the numbers are double primed. This tool construction is the same as described in the embodiment of FIGS. 1 through 6 except for the following noted differences, The threaded portion 6″ of mandrel 2″ extends the full length thereof. The magnet 13 and steel flange 12 are omitted and flange 11″ is provided with internal threads as a continuation of the internal thread of inner cylindrical section 10″.

In the present embodiment such threads may be either left or right handed but implements requiring a specific rotation direction must be chosen as appropriate to the rotation direction resulting from choice of this thread orientation. The threads chosen for this example are right handed. With this orientation implement 4″ is then rotated by mandrel 2″ in the counter clockwise direction, looking from in front of implement. This is preferred because commercial router heads such as implement 4″ with such counterclockwise directionality are easily available. The motor rotation direction will be reversed for bringing carriage 8″ to the forward position and carriage 8″ will accordingly drive implement 16″ in the opposite rotational direction (clockwise). Thus implement 16″ must be designed to operate while being rotated in a clockwise direction, looking from in front of implement.

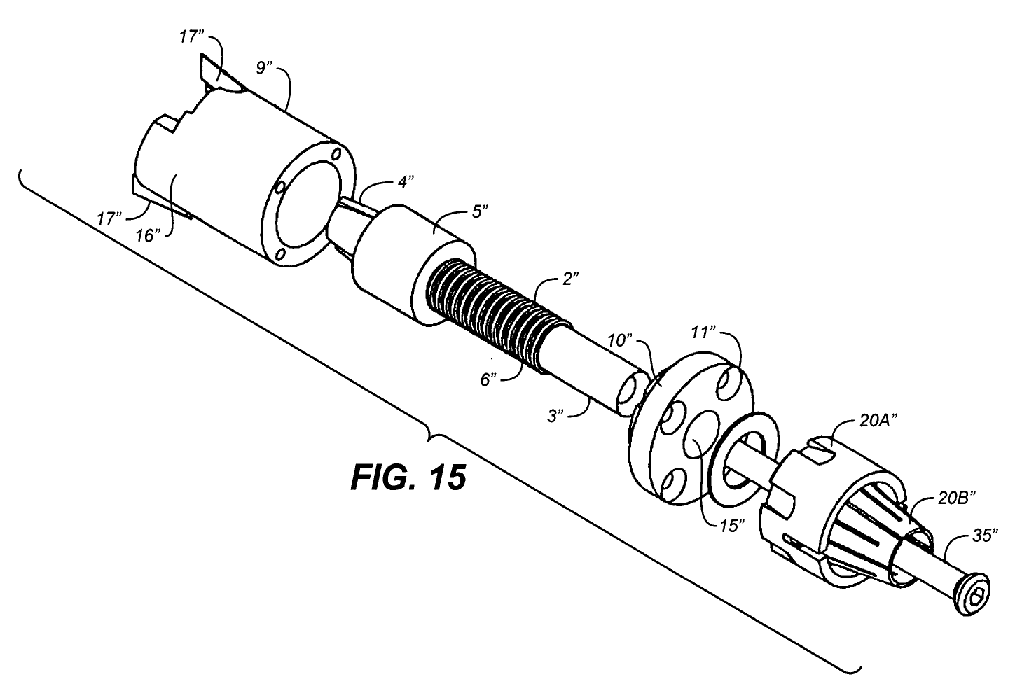

Referring to FIG. 15, it will be noted that mandrel 2″ is tubular and have a bolt 35″extending internally the length of mandrel 2″ to screw into the rear end of implement 4 to secure it in place at the forward end of mandrel 2. This arrangement may also be used in all the other embodiments in order to make it easier to change implements on the mandrel.

Operation of tool 1″ is as follows. To move carriage 8″ with router head 16″ from the inactive to the active position, mandrel 2″ is rotated in the clockwise direction, looking from in front of the mandrel. If the friction between mandrel 2″ is sufficiently low and the inertia of carriage 8″ is sufficiently high, carriage 8′ will be screwed along mandrel 2″ to the forward active position. If the friction is too high or the inertia of carriage 8″ too low, frictional drag may be applied to carriage 8″ to overcome friction, as will be described below. At the active position mandrel 2″ and carriage 8″ are interlocked as described for the embodiment of FIGS. 1 through 6 and router head 16″ will turn with mandrel 2″ for routing.

To move router head 16″ from the active to the inactive position, (and thus implement 4″ from the inactive to the active position), mandrel 2″ is rotated in the counterclockwise direction, looking from in front of the mandrel. Carriage 8″, with the application of frictional drag, if necessary, will be screwed along mandrel 2″ to reach collet 20″. Collet 20″ thus acts as an interlocking device by stopping further rearward movement of carriage 8″ and stopping counter-clockwise rotation of carriage 8″ about mandrel 2″ when at that position. At that position implement 4″ is in the active position for milling by counterclockwise rotation, looking from in front of implement.

However, inertia may not be enough to move carriage 8″ from one end of its path to the other. This may be due to sticking at one end or the other or too much friction along the way. To remedy this rotation of carriage 8″ may be restrained by hand, applying friction to it during rotation of mandrel 2″ to move carriage 8″ between the forward and rearward positions. Preferably, both for convenience and safety, friction may be applied automatically to carriage 8″ for this purpose as follows.

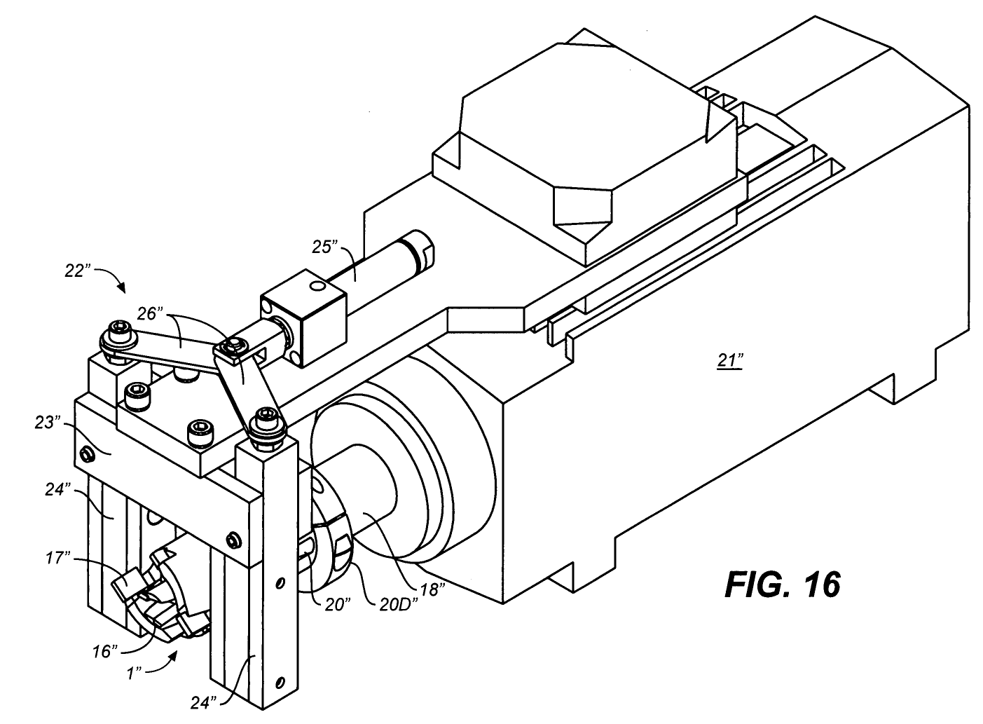

As seen in FIG. 16, tool 1″ may be mounted by securing the shank end portion 3″ bearing collet 20″ in the chuck 18″ of a two-way rotational motor 21″. A compression ring 20D″ is mounted around the retainer ring of collet 20″ engaged in chuck 18″ as a safety measure in view of the high revolutions per minute employed in routing operations. Mounted on motor 21″ is a braking system 22″ comprising a frame 23″ supporting a pair of brake shoes 24″ straddling carriage 8″ of tool 1″ mounted on the motor and an actuator system comprising a piston 25″ acting through toggle arms 26″ to open and close brake shoes 24″ against carriage 8″.

When motor 21″ is being operated to move carriage 8″ between the forward and rearward positions, arms 26″ may actuated by piston 25″, to press brake shoes 24″ against carriage 8″. This prevents carriage 8″ from rotating but still permits it to move in the axial direction by the screw action. Braking system 22″ may be operated for a short time upon each change of rotational direction for switching heads to insure that carriage 8″ is screwed to the other end of its path.

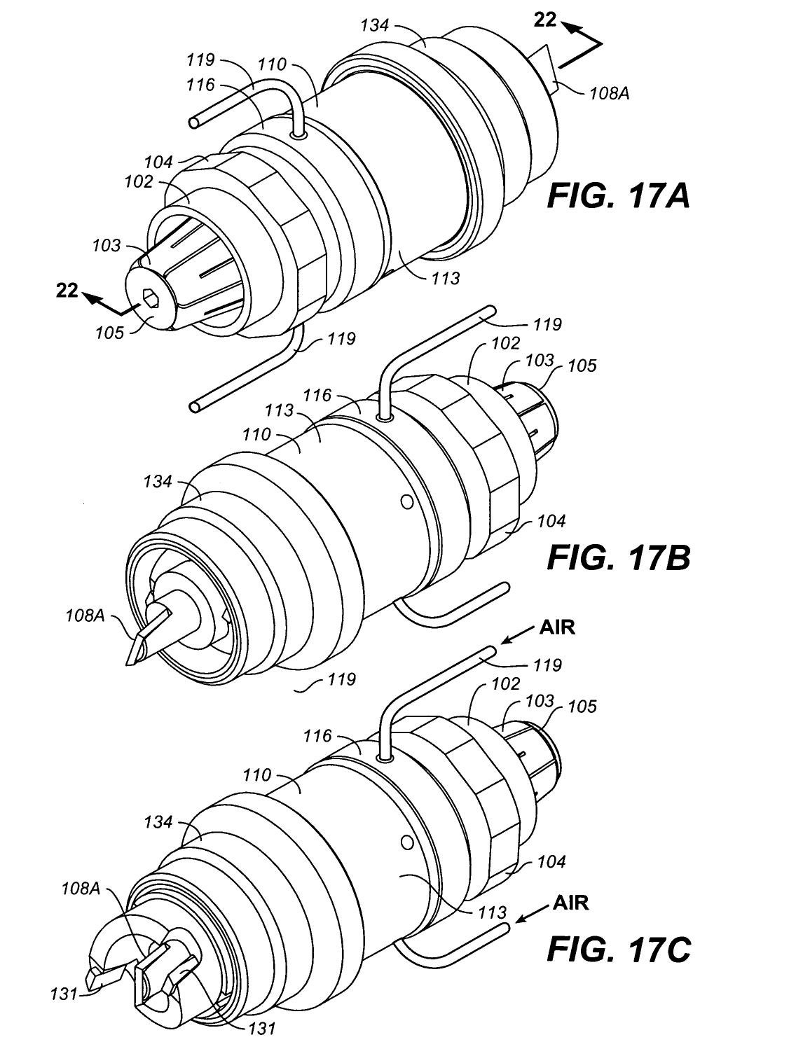

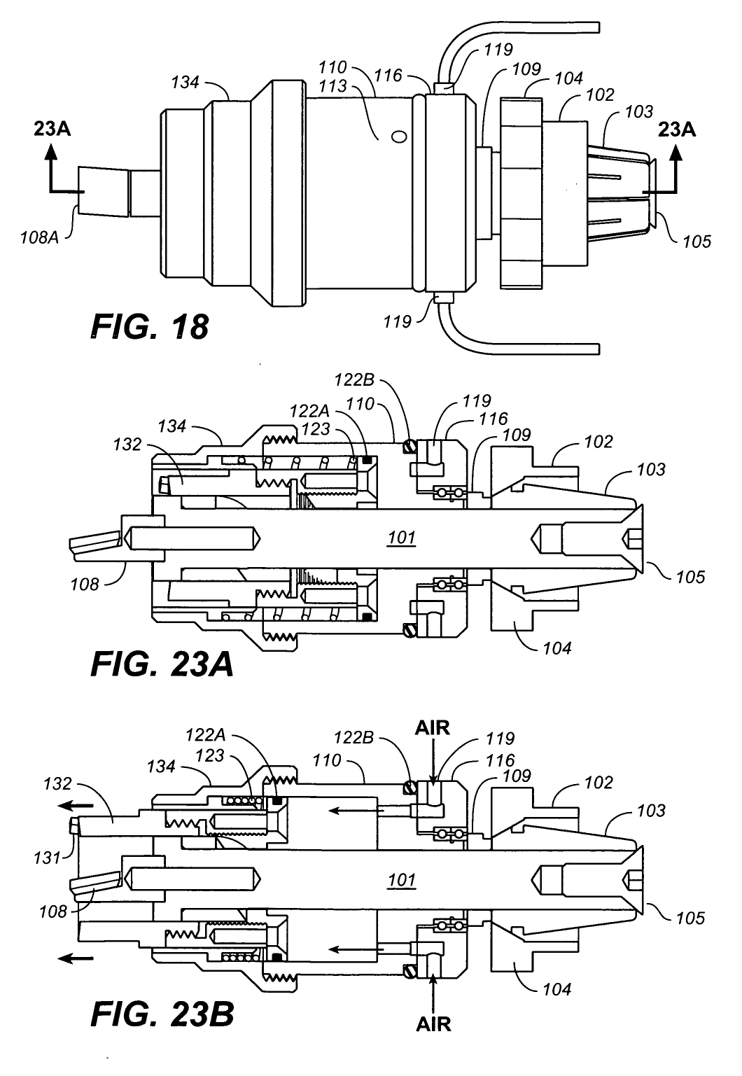

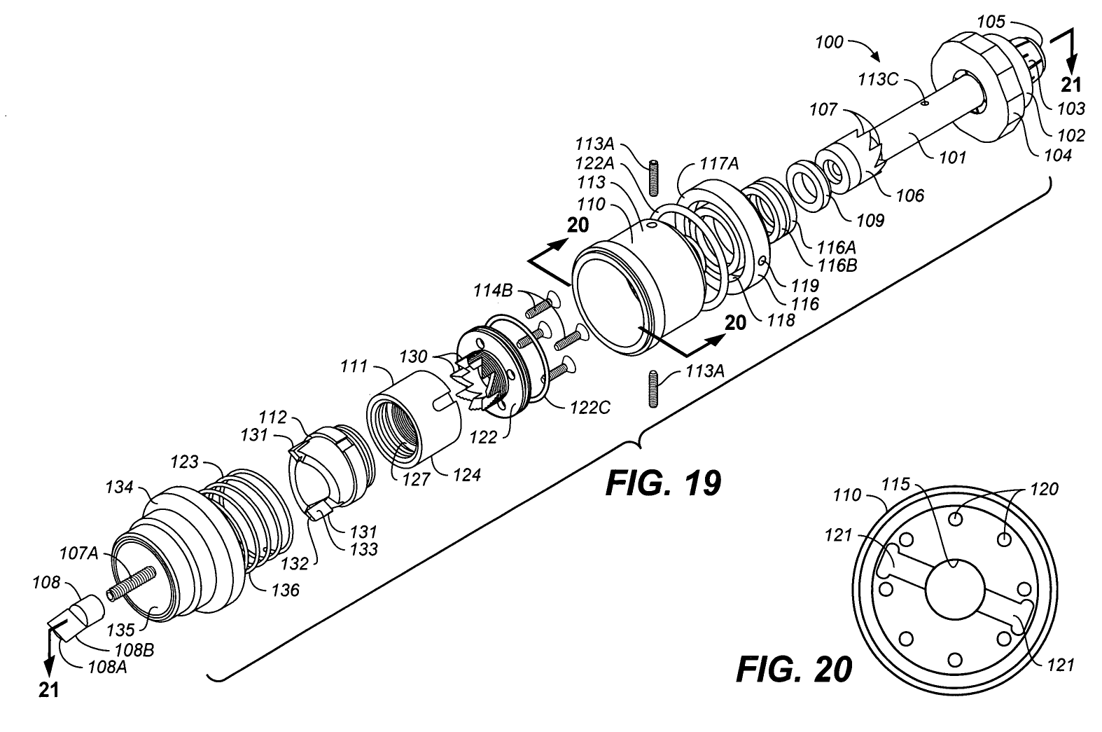

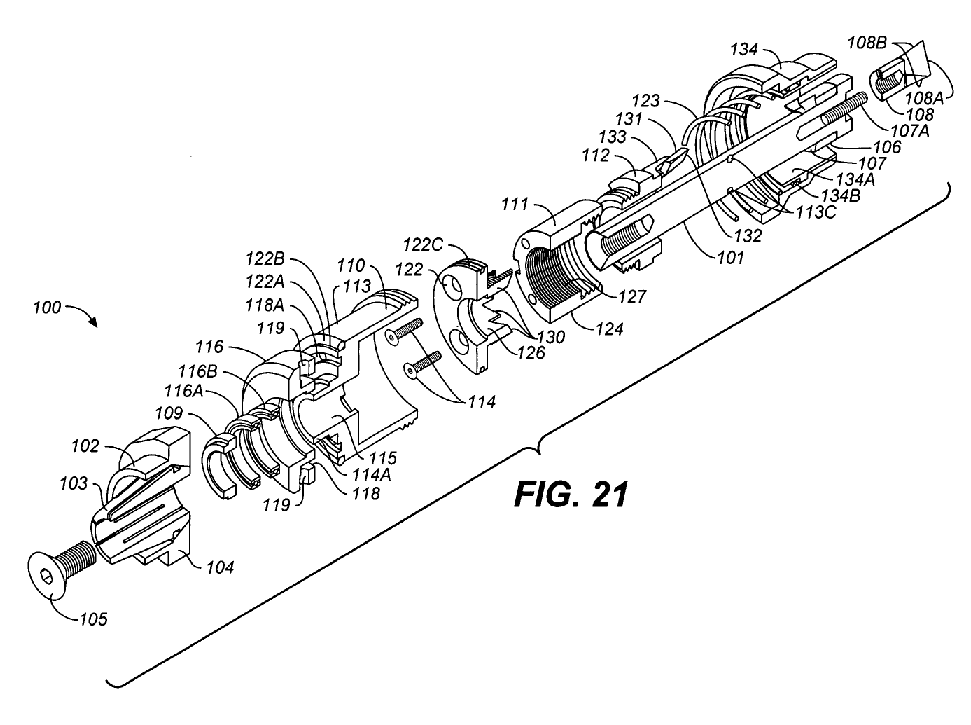

In yet another embodiment a router of this invention is capable of automatic changeover between the smaller and the larger diameter router with a motor that rotates the tool in only one direction. In this particular example the router is designed for such operation with conventional motors that impart a counter-clockwise rotation to the tool, looking from in front of the tool. As seen in FIGS. 17A through 25, dual router tool 100 is shown having a mandrel or mandrel 101 having mounted thereon at the rearward end a collet assembly 102 for engagement in the chuck of a motor arbor (not shown). The collet assembly comprises a compression body 103 having forward thereof a ring nut 104 mounted on body 103 for rotation about the axis of mandrel 101. Ring nut 104 has an open internally threaded end facing rearwardly for engagement with a motor having a tubular, externally threaded arbor. The collet assembly 102 is held on mandrel 101 by a screw 105 screwed in to the rearward end of mandrel 101.

On the front or forward end of mandrel 101 is a sleeve 106 fixed thereto. Sleeve 106 extending a distance rearwardly along mandrel 101 from the forward end thereof. A ring of teeth or locking lugs 107 extend rearwardly from the rearward end of sleeve 106 to serve as a clutch component as will be discussed below.

A central cutter, router bit 108, extending forward of mandrel 101, is secured to the forward end thereof on a screw 107A imbedded in the mandrel, for easy removal for sharpening and replacement. Router bit 108 has a forward or face cutting element, blade edge 108A, of router bit 108, that cuts in the forward or plunging direction, perpendicular to the axis of rotation of bit 108 Blade edge 108A extends transversely to the axis of mandrel 101 a distance adequate to cut an opening or hole large enough to provide the clearance for bit 108 and mandrel 101 to enter the opening to the desired routing depth. In this case example the effective forward cutting diameter of bit 108 is ½ inch.

Router bit 108 also has a side or lateral cutting element, blade edge 108B, to either side of router bit 108 and that faces outwardly of the tool axis, extending along the outer sided margins of bit 108 generally parallel to the axis of mandrel 101, to cut in directions perpendicular to the axis of rotation of the bit.

Mounted on mandrel 101 forward of collet assembly and a spacer ring 109 is cylinder motor 110 and carriage 111 for supporting and for advancing and retracting router head 112. Motor 110, coaxial with mandrel 101, comprises a cylinder 113 and a piston 122 slidably engaged in cylinder 113. Piston 122 has an “O” ring 122C at its periphery to close off the interior of the cylinder at the periphery and to allow the piston to slide therealong. Cylinder 113 has a backwall 114 with a central bore 115 that slidably engages mandrel 101. Cylinder 113 is secured to mandrel 101 by set screws 113A set in screw holes 113B and piston 122 is secured to mandrel 101 by screws 114B.

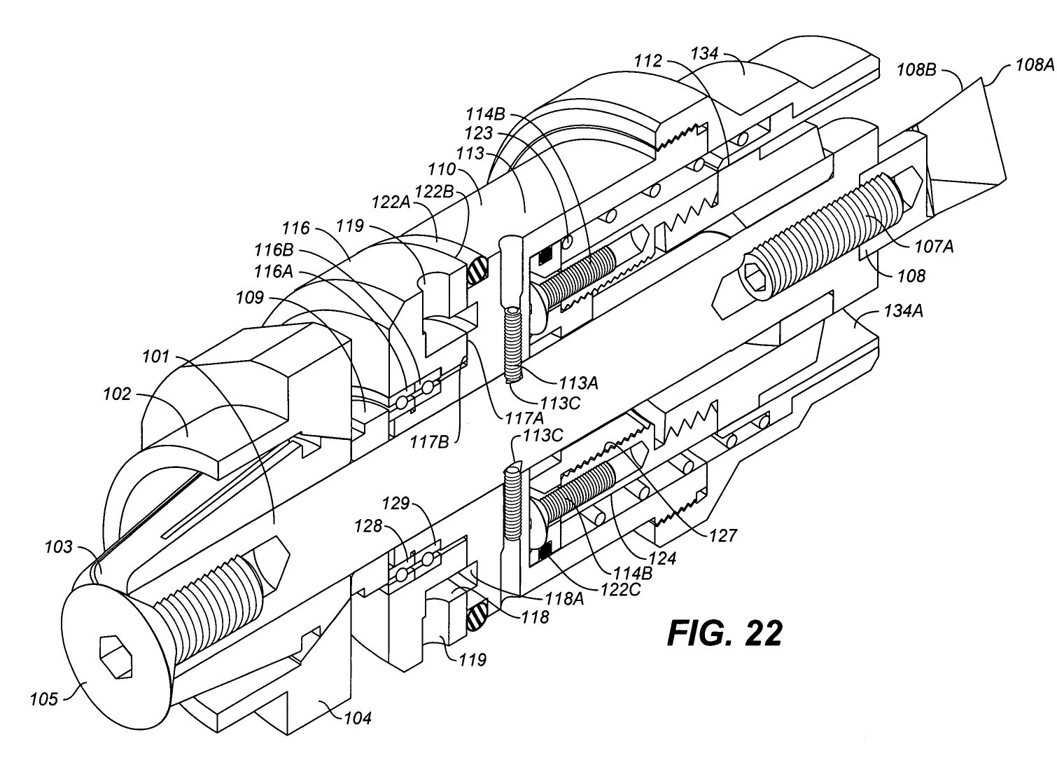

As seen particularly in FIGS. 22A-25, rearward of cylinder 113 along mandrel 101 is a compressed air supply dock 116. Dock 116 is mounted for rotation about mandrel 101 on side-by-side ball bearings 116A and 116B that, in turn, are mounted adjacent backwall 114 on a tubular extension 114A projecting rearwardly of backwall 114. Bearings 116A and 116B each has an inner race, 128 and 129, respectively, an opposed outer race, respectively, and a ring of balls held between the inner race the outer race, respectively, to permit the inner race to rotate relative to the outer race.

On the forward side of the dock 116 is structure that constitutes a rotating seal component. This seal component has a face 117A in the forward direction perpendicular to the tool axis with an annular channel 118 therein spaced between mandrel 101 and the periphery of face 117A with its opening facing in the forward direction. A pair of opposed ports 119 are at the periphery each communicating through passages between the exterior of dock 116 and channel 118.

On the rearward side of backwall 114 is also a structure that constitutes a second rotating seal component. This seal component has a face 117B in the rearward direction toward the dock that is also perpendicular to the tool axis and has an annular channel 118A therein spaced between mandrel 101 and the periphery of face 117B with its opening facing in the rearward direction. Seen most clearly in FIG. 20, a series of ports 120 is distributed around the bottom of channel 118A and each extends through backwall 114 so that air introduced into chamber formed between channels 118 and 118A through dock ports 119 will pass through backwall 114 into cylinder 113.

Face 117A of the first seal component confronts face 117B with a small gap therebetween and with the opening of channels 117A and 117B 118 and 118A registering to form a single chamber extending between the interface between the two rotating seal components. The gap at the interface of faces 117A and 117B is desirably quite small, preferably between about one and two thousands of an inch. The gap should be wide enough to prevent touching of the seals, to insure there is no friction and possible seizing up. In this respect, dock 116 preferably is made of bronze to minimize friction heat with when dock 116 rotates relative to cylinder 113 and the seal faces surfaces are desirably carefully machined to achieve a uniform gap.

As the gap becomes wider, more air escapes and this can reduce the pressure of the air going into the cylinder. To allow a wider spacing between the seal faces a flexible “O” ring 122A may, optionally, be mounted in slot 122B at the periphery of the faces to extend across the interface gap. Ring 122A may permit a somewhat wider gap, thus reducing the close surface tolerances required in manufacture of the tool. However, due to the sizing and spacing requirements for an “O” ring and the possibility of undue friction, “O” ring 122A is not recommended, particularly for the higher speed tools of this invention.

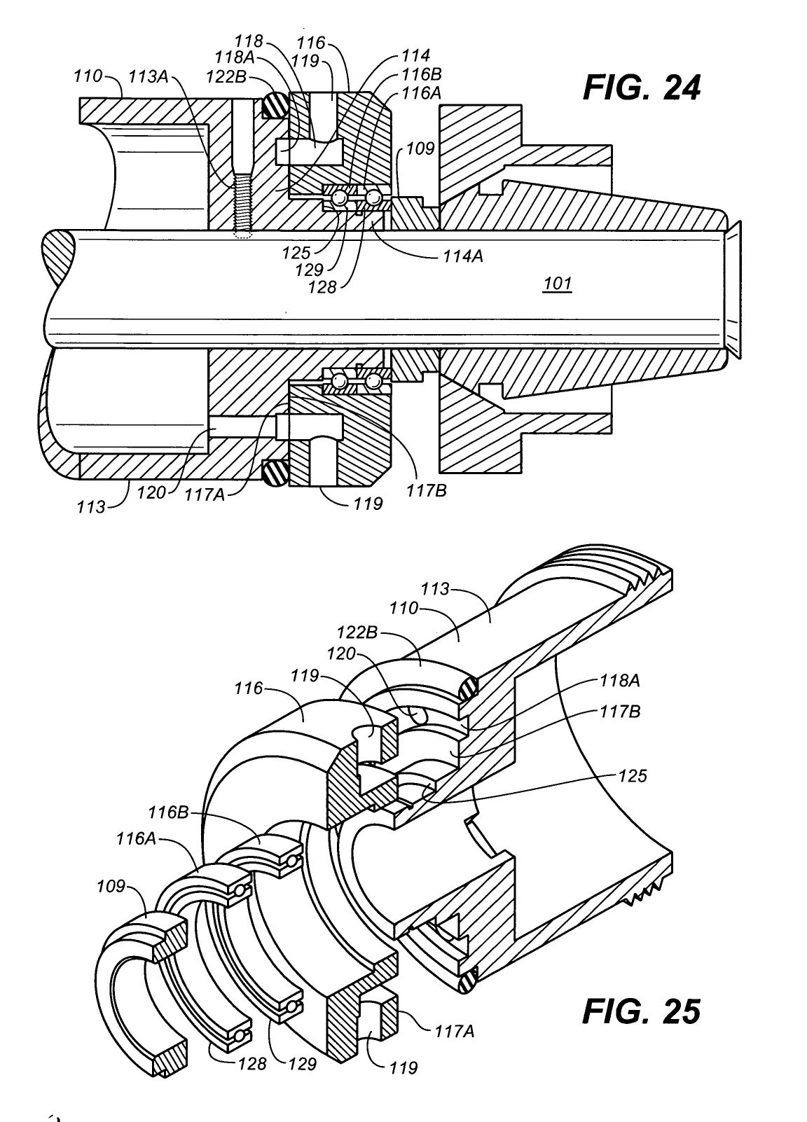

Referring now to FIGS. 24 and 25, to establish the gap at the interface of faces 117A and 117B, an annular shoulder 125 on tubular extension 114A of the cylinder abuts the inner race 129 of bearing 116B to hold bearings 116A and 116B, and with them dock 116, from further movement toward the cylinder. Shoulder 125 is machined to position it in the axial direction of the tool to provide the desired one thousands of an inch gap desired at the interface. Spacer ring 109 on the mandrel abuts the inner race 128 of bearing 116A. The rearward side of spacer ring 109 abuts the forward end of compression body 103. When collet assembly 102 of tool 100 is secured to a motor arbor with ring nut 104 tightened, compression body 103 is pressed against spacer ring 109 to thereby hold bearings 116A and 116B against shoulder 125 to maintain dock at the desired gap spacing.

A spring 123 engages the forward face of piston 122 to bias piston 122 to a rearward position against backwall 114. A pair of opposed magnets 121 are imbedded in the forward face of cylinder backwall 114, one at either side of the opening therethrough for mandrel 101 (see FIG. 20). These magnets assist spring 123 in yieldably holding piston 122 at its rearward position and also resist relative rotation between the carriage and the mandrel when the carriage is at the rearward position and to keep the piston and carriage from rotating relative to the cylinder when piston and carriage are in their rearward positions.

Carriage 111 comprises sleeve 124 around mandrel 101, attached at its rearward end to the forward face of piston 122 by screws 114B. A rear end portion 126 of the opening through sleeve 124 is of smaller diameter so as to be in slidable contact with mandrel 101, A forward end portion 127 of the sleeve opening is larger so as to provide a socket to accommodate sleeve 106 when carriage 111 is at its forward position, as seen particularly in FIG. 23B. Immediately forward of rear end portion 127 is a ring of teeth or locking lugs 130 extend forwardly that mesh with locking lugs on sleeve 106 on mandrel 101 when carriage 111 is at its forward position.

Router cutting head 112 forward of carriage 111 comprises a ring mount for a pair of cutters, bits 131, at the forward end that both lie outwardly of the central cutter 108. The bore of cutting head 112 is sized to allow passage therethrough of sleeve 108 of mandrel 101.

Each cutter bit 131 has a face cutting element comprising a cutting edge 132 extending generally transverse to the axis of mandrel 101 to cut, in the axial direction, an annular hole or groove extending from the periphery of cutting head 112 inwardly up to the edge of the path of the forward end of sleeve 106 on mandrel 101, here a distance of ¼ inch.

Each cutter bit 131 also has a side or lateral cutting element comprising cutting edge 133 facing outwardly of the tool axis and extending rearwardly from the outward tip of bit 131 the distance of the maximum routing depth desired for the tool, here a distance of 7/16 inch.

Outlying cutters or bits 131 cut an annular hole or opening while the inner cutting element cuts a hole inside this annulus leaving an annular wall (core) between the two implements about 3/16 in thick.

A generally cylindrical shield 134 having a tubular bronze inner lining 134A is fixed to the periphery of cylinder 113 and extends forward therefrom to the forward end of cutting head 112 and cutter bits 131. Lining 134A has a diameter slightly larger that the diameter of carriage 111 to normally provide clearance therebetween but is close enough to provide a bracing function for carriage 111 and mandrel 101 when the tool is subjected to bending forces transverse to the tool axis during routing. Shield 134 also serves to protection from the rotating cutters, particularly for high cutting speeds of up to 17,000 rpm for door machining operations. Shield 134 also has a slot 134B at the inner periphery of its rearward end that serves to anchor the forward end of the biasing spring 123.

As seen in FIG. 23A, when carriage 111 is at it is rearward position, router bit 108 is fully exposed by itself in front of cutting head 112 and shield 134. When mandrel 101 is rotated, the cylinder 113, which is fixed to mandrel 101, will rotate with it. Piston 122, carriage 111 and cutting head 112, although not fixed to mandrel 101, will also rotate due to the friction between cylinder 113 and piston 122. However, cutting head 112 is in the inactive position and router bit 108 is free to operate like a conventional router. Namely, tool 100 may be urged forward to use blade edge 108A to plunge into a substrate and then urged in a direction perpendicular to the tool axis to use blade edge 108B to rout a groove or other shaping in a path along the substrate surface.

As seen in FIG. 23B, when carriage 111 is at its forward engaged position, the face cutting elements of both bit 108 and bits 131 namely the face cutting edge 108A on router bit 108 and the face cutting edge on both bits 131 are essentially coterminous in the forward direction along the axis of rotation of the tool. Thus, cutting edge 108A is still exposed and positioned to cut in the axial direction along with face cutting edges 132 of cutting head 112.

Also, at that position lugs 107 on sleeve 106 engage with lugs 130 in carriage 111 and the carriage is thereby fixed to mandrel 101 and the force necessary for routing is imparted to cutting head 112 and cutter bits 131.

The front cutting path of bit 108 and the forward cutting paths of bits 131 are desirably close enough together to clear out all of the material inward of cutting head 112 so that movement of cutting head transverse to the tool axis is not impeded by a residual wall of material between the forward cutting paths. However, to avoid interference, at least a small clearance is desirable between the inner front cutting path of bit 108 and the outer forward cutting paths of bits 131. The clearance of approximately 3/16 inch between the inner and outer paths in the present example has been found satisfactory for routing wooden substrates such in processing pre-hung doors.

In operating with tool 100, it is first fixed on the chuck of a motor mounted for movement both forward in the axial direction of tool 100 and in directions transverse to the axial direction. As carriage 111 is biased to the rearward position, router bit 108 will normally be fully exposed by itself in front of cutting head 112 and shield 134 for routing operations with the smaller router alone. To operate with both router bit 108 and cutting head 112, compressed air is introduced through ports 119 of dock 116 and thus into the chamber formed between channels 118 and 118A and through ports 120 to act against the rearward face of piston 122. Piston urges carriage 111 and cutting head 112 to their forward positions for so long as the air pressure is maintained. To return to operating with only the smaller router, the compressed air supply to ports 119 is discontinued. During operation of the tool it may be useful to introduce into the compressed air input line for cylinder motor 110 a fine oil mist as this can infiltrate into bearings 116A and 116B to keep them well lubricated.

1. A routing tool that routs transversely to a rotational axis by rotation of the tool about the axis by means of cutters at a forward end thereof along the tool axis and adapted for mounted on an arbor at a rearward end of the tool along the rotational axis, the tool being capable of selectively making a narrower or wider cut, up to the maximum routing depth intended for the tool, that comprises:
a. a mandrel with its longitudinal axis at the rotational axis of the tool for supporting for rotation about the tool axis a rotary cutter at a forward axial end thereof and having a rearward end adapted for mounting on an arbor,
b. at least one central rotary cutter mounted at the forward axial end of the mandrel adapted to cut a path centrally of the mandrel axis of a desired width by rotation thereof at the forward axial end of the mandrel, the central cutter having at least one lateral cutting element that cuts outwardly of the tool axis over a distance extending in the axial direction equal to the intended maximum routing depth;
c. a carriage borne on the mandrel that is selectively movable along the mandrel between a rearward position in the direction toward the rearward end of the mandrel and a forward position in the direction of the forward end of the mandrel and that has a forward end in the axial direction toward the forward end of the mandrel; and
d. at least one rotary cutter mounted at the forward end of the carriage, the cutter lying outwardly, in the direction from the tool axis, of the central cutter and adapted to cut a path centrally of the tool axis, by rotation thereof at the forward end of the carriage, that is wider than the path cut by the central cutter, the outlying cutter having at least one lateral cutting element that cuts outwardly of the tool axis for a distance extending in the tool axial direction equal to the intended maximum routing depth; and
e. means associated with the carriage and the mandrel to stop relative rotational motion therebetween while the carriage is at the forward position; and
wherein, when the carriage is at the rearward position, the outlying cutter is rearward of the central cutter at a distance that renders the outlying cutter inactive and the central cutter exposed for routing by itself and when the carriage is at the forward position the outlying cutter is forward a distance to bring the outlying cutter at least about adjacent to the central cutter whereby to bring the lateral cutting element of the outlying cutter to a routing position outlying the central cutter and render the lateral cutting element of the central cutter inactive.

2. A routing tool as in claim 1 and wherein
a. the central cutter further comprises a forward cutting element that cuts perpendicularly to the tool axis;
b. the lateral cutting element of the central cutter extends, in the tool axis direction, rearward from the central cutting element of the central cutter;
c. the outlying cutter further comprises a forward cutting element that cuts perpendicularly to the tool axis and the outlying cutter lateral cutting element extends, in the tool axis direction, rearward from the cutting element; and,
d. when the carriage is at the forward position, the outlying cutter is forward, in the tool axis direction, a distance to bring the outlying cutter at least about adjacent to the central cutter.

3. A routing tool as in claim 2 and wherein, when the carriage is at the forward position, the forward cutting element of the central cutter and forward cutting element of the of the outlying cutter are approximately coterminous in the axial direction of the tool.

4. A routing tool as in claim 4 and wherein each of the forward cutting elements comprises at least one cutting edge transverse to the tool axis and the lateral cutting elements each comprise at least one cutting edge approximately parallel with the tool axial direction.

5. A tool as in claim 1 and wherein the means to stop relative rotation between the carriage and mandrel comprises at least one interlocking element fixed to the mandrel and at least one interlocking element fixed to the carriage, the interlocking elements adapted to automatically interlock while the carriage is at the forward position.

6. A tool as in claim 1 and wherein the means to stop relative rotation between the carriage and mandrel comprises removable elements for fixing the carriage to the mandrel.

7. A tool as in claim 6 and wherein the removable elements comprise removable pins extending through the carriage and into the mandrel.

8. A tool as in claim 1 and wherein the carriage has an internally threaded portion, the mandrel has a threaded portion at the periphery extending along the axial direction thereof forward on the mandrel from an intermediate point between the rearward and forward positions of the carriage and the mandrel is received by the carriage threaded section with the threads of the mandrel meshed with the threads of the threaded portion of the carriage so that, upon movement of the carriage forward from the rearward position until the threaded portion of the carriage reaches the mandrel screw threads the threads will be engaged by rotation of the mandrel relative to the carriage in the appropriate rotational direction and the carriage screwed to the forward position.

9. A tool as in claim 8 and wherein the means to stop relative rotation between the carriage and mandrel comprises a stop operative, when the mandrel is rotated in the direction for moving the carriage to the forward position, to stop forward movement of the carriage at the forward position and that acts, together with the meshed threads of the carriage and mandrel to stop axial rotation of the carriage relative to the mandrel when the mandrel continues to rotate in the forward position for rotating the rotary cutters.

10. A tool as in claim 9 and further including a detent selectively operable when the carriage has moved to the rearward position to releasably restrain the carriage from movement forward of the rearward position.

11. A tool as in claim 10 and wherein the detent comprises a magnet located behind the rearward position of the mandrel.

12. A tool as in claim 1 and wherein the carriage has an internally threaded portion, the mandrel has screw threads at the periphery extending along the axial direction thereof and the mandrel is received by the carriage with the threads of the mandrel meshed with the threads of the threaded portion of the carriage whereby, upon rotation of the mandrel relative to the carriage in the appropriate rotational direction, the carriage may be selectively moved along the mandrel threads in either axial direction, between the rearward position and the forward position.

13. A tool as in claim 12 and wherein the means to stop relative rotation between the carriage and mandrel comprises a stop operative, when the mandrel is rotated in the direction for moving the carriage to the forward position, to stop forward movement of the carriage at the forward position, that acts together with the meshed threads of the carriage and mandrel to stop axial rotation of the carriage relative to the mandrel when the mandrel continues to rotate in the forward position for rotating the rotary cutters.

14. A tool as in claim 13 and wherein the mandrel threads are right hand and the central rotary cutter is operable to cut when rotated in the counterclockwise direction looking from the front of the tool and the outlying cutter is operable to cut when rotated in the clockwise direction, looking from in front of the tool.

15 A tool as in claim 14 and further including a motor having an arbor for rotation, the motor capable of selectively rotating in the clockwise and counterclockwise directions, the tool being mounted for rotating the mandrel in a clockwise or counterclockwise direction, as selected, to thereby move the carriage between the forward and rearward positions, respectively.

16. A tool as in claim 15 and further including a brake selectively operable against the carriage to slow rotational movement thereof as the mandrel is rotated, thereby to facilitate movement of the carriage in the axial direction between the forward and rearward positions.

17. A tool as in claim 1 which further including means for automatically moving the carriage between the forward and rearward positions that comprises:
a. a linear pneumatic cylinder motor positioned axially rearward of the carriage and comprising a cylinder component and a piston component, the piston being slidably engaged in the cylinder for movement along the length of the cylinder to thereby cause relative movement between the said motor components in opposed directions, one of said components being fixed to the mandrel and the other said component being fixed to the carriage, the piston being moveable between a first location, at which the carriage is at the rearward position, a second location, at which the carriage is at the forward position;
b. means for conducting compressed gas into the cylinder for driving the piston from the rearward position and forward position thereof; and
c. means for moving the piston from the forward position to the rearward position.

18. A tool as in claim 17 and wherein the motor is received on the mandrel with the cylinder component and piston component concentric with the mandrel and with the component that is fixed to the carriage being slidable along the mandrel and the other component being fixed to the mandrel.

19. A tool as in claim 1 which further including means for automatically moving the carriage between the forward and rearward positions that comprises:
a. a linear pneumatic cylinder motor positioned axially rearward of the carriage and comprising a cylinder and a piston, the motor being received on the mandrel with the cylinder and piston concentric therewith, the piston being slidably engaged in the cylinder for movement along the length of the cylinder, slidable along the mandrel and attached to the carriage and the cylinder being fixed to the mandrel, and wherein the piston is movable between a location at which the carriage is at the said rearward position and a location at which the carriage is at the forward position;
b. means for introducing compressed gas into the cylinder for driving the piston from the rearward position to the forward position thereof; and
c. means for moving the piston from the forward to the rearward position.

20. A tool as in claim 19 and wherein the cylinder component has a rearward wall toward the rearward end thereof along the tool axis is attached to the mandrel and toward the rearward end thereof.

21. A tool as in claim 20 and wherein the means for introducing compressed gas into the cylinder comprises
a. a dock rearward of the cylinder, the dock being received on the mandrel for rotation therearound and fixed against movement in the axial direction of the tool;
b. a first rotary seal component at the side of the dock toward the cylinder rearward wall and fixed thereto, the first component extending outwardly of and encircling the mandrel and having a face toward the said cylinder rearward wall;
c. a second rotary seal component on the side of the rearward cylinder wall toward the dock and fixed thereto, the second component extending outwardly of and encircling the mandrel and having a face confronting and closely spaced from the first rotary seal component face to form an interface gap therebetween; and
d. at least one passage communicating through the dock from the exterior thereof and, inwardly of the rotary seal components, to and through the cylinder rearward wall, and
wherein the gap is between the said faces is sufficiently small to permit the gas supply through the conduit at a pressure to force the carriage to and hold the carriage at the forward position during operation of the tool.

22. A tool as in claim 21 and wherein the face of each rotary seal components is planar and perpendicular to the tool axis and the passage further comprises a chamber between the dock and the rearward end of the cylinder, the chamber spaced outwardly of and encircling the mandrel and spaced inwardly of the rotary seal components and extending at least to the interface gap and the passage communicating from the exterior of the dock to the interior of the cylinder through the chamber.

23. A tool as in claim 21 and wherein the chamber comprises an annular channel at the interface concentric with the tool axis, the channel being open toward the interface gap and in communication with the passage extending to the interior of the cylinder.

24. A routing tool that routs transversely to a rotational axis by rotation of the tool about the axis by means of cutters at a forward end thereof along the rotational axis and adapted for mounted on an arbor at a rearward end of the tool along the rotational axis, the tool being capable of selectively making a narrower or wider cut, up to the maximum routing depth intended for the tool, that comprises:
a. a mandrel with its longitudinal axis at the rotational axis of the tool for supporting for rotation about the tool axis a rotary cutter at a forward axial end thereof and having a rearward end adapted for mounting on an arbor,
b. at least one central rotary cutter mounted at the forward axial end of the mandrel adapted to cut a path centrally of the mandrel axis of a desired width by rotation thereof at the forward axial end of the mandrel, the central cutter having at least one forward cutting element that cuts perpendicularly to the tool axis and at least one lateral cutting element that cuts outwardly of the tool axis over a distance extending rearwardly, in the tool axial direction, from the cutting element a distance equal to the intended maximum routing depth;
c. a carriage borne on the mandrel that is selectively movable along the mandrel between a rearward position in the direction toward the rearward end of the mandrel and a forward position in the direction of the forward end of the mandrel and that has a forward end in the axial direction toward the forward end of the mandrel; and
d. at least one rotary cutter mounted at the forward end of the carriage, the cutter lying outwardly, in the direction from the tool axis, of the central cutter and adapted to cut a path centrally of the tool axis, by rotation thereof at the forward end of the carriage, that is wider than the path cut by the central cutter, the outlying cutter having at least one forward cutting element that cuts perpendicularly to the tool axis and at least one lateral cutting element that cuts outwardly of the tool axis and extends, in the tool axial direction, from the forward cutting element for a distance extending equal to the intended maximum routing depth; and
e. means associated with the carriage and the mandrel to stop relative rotational motion therebetween while the carriage is at the forward position; and
wherein, when the carriage is at the rearward position, the outlying cutter is rearward of the central cutter at a distance that renders the outlying cutter inactive and the central cutter exposed for routing by itself and when the carriage is at the forward position the outlying cutter is forward a distance to bring the outlying cutter forward element to a position that is approximately coterminous in the tool axis direction with the forward element of the central cutter, whereby to bring the lateral cutting element of the outlying cutter to a routing position outlying the central cutter and render the lateral cutting element of the central cutter inactive.

25. A routing tool that routs transversely to a rotational axis by rotation of the tool about the axis by means of cutters at a forward end thereof along the rotational axis and adapted for mounted on an arbor at a rearward end of the tool along the rotational axis, the tool being capable of selectively making a narrower or wider cut, up to the maximum routing depth intended for the tool, that comprises:
a. a mandrel with its longitudinal axis at the rotational axis of the tool for supporting for rotation about the tool axis a rotary cutter at a forward axial end thereof and having a rearward end adapted for mounting on an arbor,
b. at least one central rotary cutter mounted at the forward axial end of the mandrel adapted to cut a path centrally of the mandrel axis of a desired width by rotation thereof at the forward axial end of the mandrel, the central cutter having at least one lateral cutting element that cuts outwardly of the tool axis over a distance extending in the axial direction equal to the intended maximum routing depth;
c. a carriage borne on the mandrel that is selectively movable along the mandrel between a rearward position in the direction toward the rearward end of the mandrel and a forward position in the direction of the forward end of the mandrel and that has a forward end in the axial direction toward the forward end of the mandrel; and
d. at least one rotary cutter mounted at the forward end of the carriage, the cutter lying outwardly, in the direction from the tool axis, of the central cutter and adapted to cut a path centrally of the tool axis, by rotation thereof at the forward end of the carriage, that is wider than the path cut by the central cutter, the outlying cutter having at least one lateral cutting element that cuts outwardly of the tool axis for a distance extending in the tool axial direction equal to the intended maximum routing depth; and
e. means associated with the carriage and the mandrel to stop relative rotational motion therebetween while the carriage is at the forward position;
f. a linear pneumatic cylinder motor positioned axially rearward of the carriage and comprising a cylinder component and a piston component, the cylinder being slidably engaged in the cylinder for movement along the length of the cylinder to thereby cause relative movement between the said components in opposed directions, one of said components being fixed to the mandrel and the other said component being fixed to the carriage, the piston being moveable between a first location, at which the carriage is at the rearward position, a second location, at which the carriage is at the forward position;
g. means for conducting compressed gas into the cylinder for driving the piston from the rearward position and forward position thereof; and
h. means for moving the piston from the forward position to the rearward position; and
wherein, when the carriage is at the rearward position, the outlying cutter is rearward of the central cutter at a distance that renders the outlying cutter inactive and the central cutter exposed for routing by itself and when the carriage is at the forward position the outlying cutter is forward a distance to bring the outlying cutter at least about adjacent to the central cutter whereby to bring the lateral cutting element of the outlying cutter to a routing position outlying the central cutter and render the lateral cutting element of the central cutter inactive.

26. A tool as in claim 25 and wherein the chamber comprises an annular channel at the interface concentric with the tool axis, the channel being open toward the interface gap and in communication with the passage extending to the interior of the cylinder.

27. A tool as in claim 26 and wherein the means for introducing compressed gas into the cylinder comprises
e. a dock rearward of the cylinder, the dock being received on the mandrel for rotation therearound and fixed against movement in the axial direction of the tool;
f. a first rotary seal component at the side of the dock toward the cylinder rearward wall and fixed thereto, the first component extending outwardly of and encircling the mandrel and having a face toward the said cylinder rearward wall;
g. a second rotary seal component on the side of the rearward cylinder wall toward the dock and fixed thereto, the second component extending outwardly of and encircling the mandrel and having a face confronting and closely spaced from the first rotary seal component face to form an interface gap therebetween; and
h. at least one passage communicating through the dock from the exterior thereof and, inwardly of the rotary seal components, to and through the cylinder rearward wall, and
wherein the gap is between the said faces is sufficiently small to permit the gas supply through the conduit at a pressure to force the carriage to and hold the carriage at the forward position during operation of the tool.
